(19) United States
(12) Patent Application Publication
(10) Pub. No.: US 2013/0211609 A1
(43) Pub. Date: Aug. 15, 2013

(54) METHOD FOR PLANNING AND/OR CONTROLLING AN ENERGY OUTPUT TO A CONSUMER AND/OR AN ENERGY SUPPLY TO AN ENERGY DISTRIBUTION NETWORK

(71) Applicants: Joachim Edtmair, Gallneukirchen (AT); Wolfgang Bernhard, Gallneukirchen (AT)

(72) Inventors: Joachim Edtmair, Gallneukirchen (AT); Wolfgang Bernhard, Gallneukirchen (AT)

(73) Assignee: ATB AUTOMATISIERUNGSTECHNIK GMBH & CO KG, A-4210 Gallneukirchen (AT)

(21) Appl. No.: 13/810,341

(22) PCT Filed: Jul. 8, 2011
(86) PCT No.: PCT/AT11/00296

§ 371 Date: Feb. 1, 2013

(30) Foreign Application Priority Data
Jul. 16, 2010 (AT) A 1210/2010

(51) Int. Cl. G05B 13/02

(52) U.S. Cl. CPC G05B 13/02
USPC 700/286

(57) ABSTRACT

A method for planning and/or controlling an energy output to a consumer and/or an energy supply to an energy distribution network includes generating at and transmitting from a first energy supplier first messages relating to current tariffs and/or planned tariffs to be expected and/or expected network loads, and relating to a value for a probability that the expected current or planned tariffs and the expected network capacity utilization will actually occur.

The invention relates to a method according to the preamble of claim 1.

It is known and planned by utility companies to switch or trigger electrical consumers by the operator of the energy supply network, which consumers are arranged in a subscriber of an energy supply network and are connected there to said energy supply network. It is provided for example that a specific need for electrical power is reported by the subscriber or user to the utility company within a specific period of time. The utility company will then connect the individual subscribers within the applied period of time on the basis of the different received respective enquiries of a plurality of subscribers in order to achieve favorable capacity utilization of an existing supply network and in order to especially avoid overloading of the supply network.

It is disadvantageous that as a result of bidirectional communication the utility company will be granted insight into the privacy of the subscriber. This is problematic for reasons of data protection and privacy protection. On the basis of the reported demand, conclusions can be drawn on the electrical appliance to be operated such as a hot water boiler, an electric car, garden watering systems or the like. Consequently, conclusions can be drawn on the circumstances of the subscriber such as the number of inhabitants in a respective household, the time during which the subscriber is at home etc. The subscribers are then subsequently unable to determine or limit the exploitation of their data. Furthermore, unauthorized access to these data cannot be excluded. The subscriber is further forced to use the utility company concerning the actual operation of his or her appliances and is therefore no longer “master in his or her own house”.

The further disadvantageous aspect in known practice is the low flexibility in the issuing of tariffs and the low possibility for planning energy consumption and the network load. New tariffs will be issued only rarely due to the currently existing commitment of the announced tariff. Consequently, although there will usually be a change from a high-price tariff to a low-price tariff twice-daily and vice versa, there are no short-term tariffs which could be issued as a result of short-term shortages or especially high energy production. Especially when using so-called renewable energies, which often required specific environmental influences, the announcement of a special tariff is problematic since often the forecast delivery quantities cannot be supplied due to environmental conditions. Planning of network utilization and planning of energy consumption will be rendered considerably more difficult as a consequence, or it will be performed in a manner that is not based on the real conditions. As a result of the lack of tariffs that can be applied over short periods of time and other information on controlling the network utilization or consumer behavior, it is not possible to provide planning that takes into account the real conditions of energy production and network loading.

It is therefore the object of the invention to provide a method of the kind mentioned above with which the mentioned disadvantages can be avoided, and with which a constant network capacity utilization and supply-oriented consumption planning can be achieved.

This will be achieved in accordance with the invention by the features of claim 1.

This leads to the possibility of more flexible planning of the tariffs and network capacity utilization. In this respect, not only will a tariff be offered and network capacity utilization will be forecast, but the respective information which can be supplemented with additional information is provided with an additional probability value, which probability value will indicate the probability with which the information will occur. As a result of repeated updates of the first messages, the probability value can also be adjusted continually. This leads to the possibility of long-term planning of energy use for the consumer for example because it can be estimated whether the respective tariff will actually occur, depending on the weather conditions for example. This will lead in particular to considerable improvements in middle-term planning in the range from between a few hours up to a few days.

This grants energy suppliers the further possibility to offer tariffs more frequently and at different levels, because they can be adjusted over time until they actually come into effect. On the consumer side, this leads to the special advantage of planning the purchase of energy over a longer period of time and with more flexibility. The own energy consumption, its time frame and optionally separate energy production can be planned in a better way especially by comparing the so-called tariff and network capacity utilization forecasts of different suppliers and energy producers, which may also comprise an in-house photovoltaic installation.

he measures as explained above will lead to an advantageous situation for all parties involved. The operator of the energy distribution network profits from the improved and especially more balanced capacity utilization of the distribution network, with load peaks being reduced. The subscriber or customer and the operator will profit from better planning possibilities. The suppliers of environment-dependent energy production will profit from a more effective capacity utilization of energy production and therefore from more effective planning capability. The general population will profit from the better utilization of alternative energy production and better utilization of the power lines. As a result, the burden on the electricity distribution networks can be reduced and the energy costs for the consumers can be reduced. Consequently, better capacity utilization of the electricity distribution networks can be achieved and an expansion of the electricity distribution networks can be avoided.

The invention relates further to a method according to claim 9.

It is the object of the invention to provide a method of the kind mentioned above with which the mentioned disadvantages can be avoided and with which constant network capacity utilization can be achieved by ensuring data protection.

This is achieved in accordance with the invention by the features of claim 9.

Good and constant network capacity utilization as well as capacity utilization of the energy distribution network can be achieved in this way, wherein there are no objections concerning the protection of the privacy of the subscribers at the same time because no data are transmitted to the utility company. The required energy quantity will be supplied to the consumer in at least one section at which the utility company indicated a non-critical network capacity utilization. If the utility company merely issues tariff information, the possibility for planning the point in time will be provided at which the respective consumer will be connected with the energy distribution network on the basis of said tariff information, by means of which the same effects will be achieved. Tariffs will usually be arranged by the utility companies with respect to different network capacity utilizations which prevail at different points in time, so that a low-cost tariff at a specific point in time will mean low network capacity utilization and therefore free capacities. Consequently, the “switching control rights” remain with the subscriber and will not be passed on to the utility company.

The invention further relates to a method according to claim 14.

The consumer or subscriber of an energy supply network will usually conclude an agreement with a specific utility company. The subscriber is subsequently bound to this consumer and is therefore unable to respond to or accept offers of other utility companies. Consequently, the subscriber or customer has no influence on the pricing arrangement and the type of the offered energy. A customer is currently not in the position to purchase power from wind power plants in a purposeful manner for example or to avoid power that is produced in a manner that is highly detrimental to the environment.

It is therefore the object of the invention to provide a method of the kind mentioned above with which the mentioned disadvantages can be avoided and with which a possibility for selecting the energy to be purchased by the subscriber can be achieved.

This is achieved in accordance with the invention by the features of claim 13.

It can consequently be ensured that a subscriber of an energy distribution network is supplied with such energy (if available and offered) which meets the demands of the subscriber concerning costs or environmental compatibility for example. This allows the subscriber or consumer to act on the utility company by intentionally predetermining the energy purchase guidelines, since subscribers may be willing to pay higher prices for power and/or heat produced in an especially ecologically sustainable manner than power from an atomic power plant.

The dependent claims relate to further advantageous embodiments of the invention.

Express reference is made hereby to the wording of the claims, by means of which the claims shall be inserted into the description at this point by reference and shall apply as being literally reproduced.

The invention will be described below in closer detail by reference to the enclosed drawings which merely show preferred embodiments by way of example, wherein:

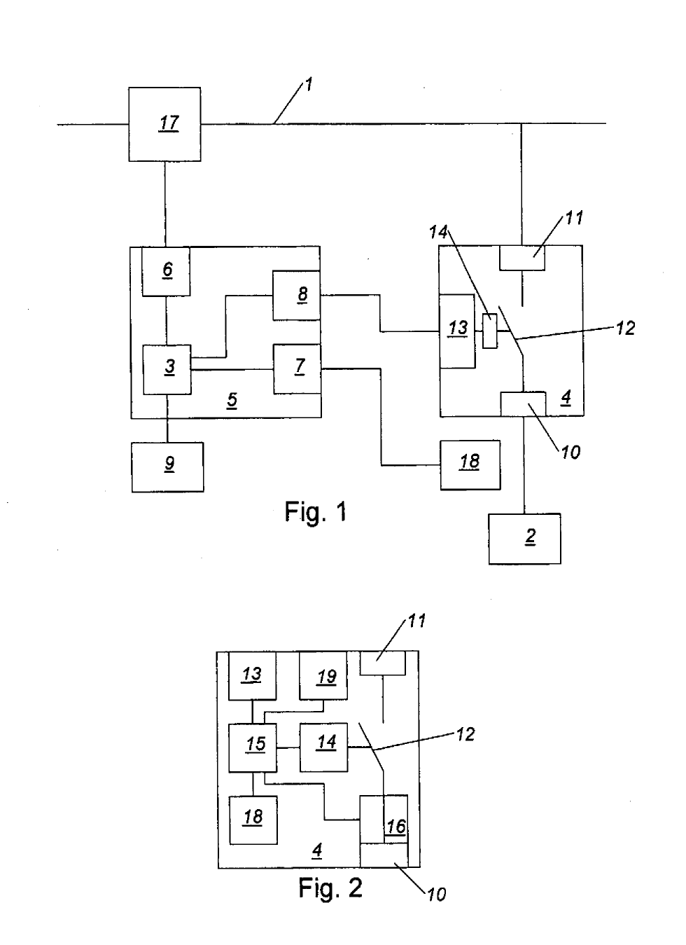

FIG. 1 shows an especially preferred embodiment of a system in accordance with the invention with a first especially preferred embodiment of a switching device in accordance with the invention, and

FIG. 2 shows a second, especially preferred embodiment of a switching device in accordance with the invention.

FIG. 1 shows an especially preferred embodiment of a system in accordance with the invention for controlling an energy output to at least one consumer 2 connected to an energy distribution network 1, which system comprises an apparatus 5 for controlling the energy output to at least one consumer 2 connected to an energy distribution network 1, which apparatus 5 comprises at least one first communication interface 6 for receiving first messages of a first utility company, a second communication interface 7 for receiving first demand data of the consumer 2, a control interface 8 for the at least indirect switching of the consumer 2, and a first control unit 3 for controlling the energy output to the consumer 2. Furthermore, the preferred system according to FIG. 1 comprises a switching device 4 which is suitable or arranged for the predeterminable start-up of a consumer 2 connected to the switching device 4, with the switching device 4 comprising a current delivery interface 10 and a current receiving interface 11, and switching contacts 12 which in a closed position close a current path between the current delivery interface 10 and the current receiving interface 11, with the switching device 4 further having a third communication interface 13 for receiving a switching order, and an actuator 14 for actuating switching contacts 12.

A favorable and constant network capacity utilization or capacity utilization of the energy distribution network 1 can be achieved by means of such a system, wherein there are no objections concerning the protection of the privacy of the subscriber at the same time. This allows operating the consumer 2 in periods of uncritical network capacity utilization. The energy costs of a consumer can further be reduced by means of such a system, in that the respective cheapest utility company is chosen among several such companies.

Systems in accordance with the invention are preferably provided for application with different energy supply networks 1, and therefore networks for supplying subscribers with power or the distribution of power, especially for networks for supplying power in form of electrical energy or thermal energy. Consequently, the two especially preferred types of energy supply networks concern electrical distribution networks and long-distance heating networks, with an especially preferred embodiment of the present invention being explained below in closer detail by reference to an electrical energy supply network 1.

An apparatus 5 for controlling energy output to at least one consumer 2 connected to an energy distribution network 1 comprises at least one first communication interface 6 which is provided and/or arranged for receiving first messages of a first utility company. The first messages preferably are or comprise information concerning the supply with energy such as preferably data concerning current and/or future tariffs and/or current and/or future network capacity utilizations and/or special offers such as a packet of electrical power within a specific period of time (e.g. the purchase of 5 kWh within the next two hours at a specific price), and/or concerning the type of energy production, especially whether offered electrical power was or will be generated from so-called renewable energy such as hydraulic power, solar energy or wind energy, or by combustion of fossil or sustainable fuels, or in an atomic power plant. The information can also comprise the energy quantity that can be supplied and/or planned electrical power that can be supplied and/or maximum available power and/or a planned strength of current that can be supplied.

Furthermore, the first messages contain at least a value for a probability of the actual occurrence of the respective tariffs and/or network capacity utilizations. The indicated probability value can relate both to the probability of network capacity utilization, and/or a probability of the supplied quantity, and/or a probability of the tariff and/or also to a spread of the tariff. It can further be provided that the at least one probability value relates to the indication of a quantity of energy which will be provided under the mentioned conditions, or the provision of which is planned with a specific probability.

The information on the first messages further also relates to the aforementioned second and third messages.

It is preferably provided that meteorological forecast data and statistical network loading data are evaluated, and tariffs and/or network capacity utilizations are planned on the basis of said data, and a value is determined for the probability of maintaining the planned tariffs and/or network capacity utilizations.

Subsequently, the terms of energy supplier and utility company will partly be used synonymously. This shall also include small power plants such as small wind power plants or photovoltaic installations in addition to the utility companies.

These first messages will be provided by the first energy supplier or utility company and transmit them via the network line or via any other line-bound or wireless interface to the electric current meter 17. It is preferably provided that the first communication interface 6 is arranged as a wire-bound interface such as powerline, TCP/IP or the like, or as a radio interface such as GSM, UMTS or the like. Mixed solutions can also be provided such as a combination of a wire-bound interface and a wireless LAN modem.

It is provided in an especially preferred manner that the first communication interface 6 is arranged as a unidirectional interface and merely comprises one receiving part. As a result, the transmission of data to the utility company can be prevented permanently and in a manner to securely prevent manipulation. For the purpose of confirming the acceptance of a tariff, a bidirectional interface can be provided which enables duplex-capable communication.

The apparatus 5 comprises a first control unit 3 for controlling the energy output to the consumer 2. Furthermore, the first control unit 3 is preferably provided and arranged to control the data exchange of the apparatus 5 with further components and to optionally store occurring data, for which purpose the first control unit 3 preferably comprises a memory or is connected with such a memory by means of circuitry.

The first control unit 3 is preferably arranged as a microcontroller or microprocessor, wherein an arrangement as a discretely configured state machine can also be provided.

The apparatus 5 further comprises a second communication interface 7 for receiving first demand data of the consumer 2. The second communication interface 7 is provided and arranged for the input of at least one operating parameter of at least the consumer 2. This interface can be arranged in any form, which allows receiving the respective data and transferring the same to the first control unit 3. In accordance with an especially simple embodiment of an apparatus 5 it is provided that the second communication interface 7 is arranged as a predeterminable number of switches and/or buttons, especially as a preferably alphanumeric keyboard, which is arranged directly on or in the apparatus 5.

It is provided according to the preferred embodiment as shown in FIG. 1 that the second communication interface 7 is arranged as a line-bound interface, to which a second input unit 18 (preferably a keyboard) is connected by means of circuitry. This leads to the advantage that several second input units 18 can be provided which are connected to the second communication interface 7, or are in connection with said interface, and which can be respectively arranged at a location where this is regarded as being advantageous for operative reasons.

The second communication interface 7 is preferably arranged as any kind of a wire-bound or radio interface, with especially the arrangement as a bidirectional interface being provided, and/or the arrangement as a bus interface such as USB, Ethernet or IEEE 1394, by means of which several second input units 18 can be triggered by the second communication interface 7. Furthermore, an arrangement of the second communication interface 7 as a TCP/IP modem can be provided, in addition to further circuit modules required for this purpose.

The apparatus 5 further comprises a control interface 8 for switching the consumer 2 at least indirectly. It is provided according to an especially simple embodiment that the control interface 8 provides two electrically unique states such as high and low, with one of the states meaning an activation of a consumer 2 and the other state a deactivation of the respective consumer 2. It is preferably provided that the control interface 8 is arranged for switching a relay or a semiconductor circuit, or forms a part of an analog or digital control circuit in a further development. It is preferably provided that the control interface 8 is arranged as a bus interface such as EIB, KNX, Powerline, or as an interface for triggering radio actuators, by means of which several consumers 2 can be switched with an apparatus 5.

An especially preferred further embodiment of an apparatus in accordance with the invention comprises at least one fourth communication interface for transmitting information to at least the first utility company and/or a second utility company. As a result, data exchange from the apparatus 5 to the at least one first utility company can occur and statistical data can be transmitted thereby or—as will be explained below in closer detail—the acceptance of an offered tariff can be confirmed.

FIG. 1 shows among other things a block diagram of a preferred embodiment of an apparatus 5, with the first communication interface 6 being connected with the first control unit 3 by way of circuitry, which is connected by way of circuitry both with the second communication interface 7 and also the control interface 8. The first communication interface 6 is connected by way of telecommunications, i.e. with a connection which enables the transmission of information, with the electric current meter 17. The second communication interface 7 is also connected by way of telecommunications as explained above with the second input unit 18.

In accordance with the illustrated preferred embodiment, the first control unit 3 is connected with the first input unit 9.

In addition, the apparatus 5 preferably comprises a power unit for power supply. It can further be provided that a first input unit 9 such as a keyboard is connected with the first control unit 3, by means of which general configurations of the apparatus 5 or the entire system are simplified. It can be provided in this respect that the first and second input unit 9, 18 are integrally arranged, or that further a conventional PC is connected with the first control unit 3.

It is preferably provided that the individual modules of the apparatus 5 are arranged in a housing made of an insulating material.

FIG. 1 further shows a first preferred embodiment of a switching device 4 in accordance with the invention for the predeterminable start-up of a consumer 2 which is connected with the switching device 4, with the switching device 4 having a current delivery interface 10 and a current receiving interface 11, and switching contacts 12 which in a closed position close a current path between the current delivery interface 10 and the current receiving interface 11, with the switching device 4 further having a third communication interface 13 for receiving a switching order, and an actuator 14 for actuating the switching contacts 12. Such a switching device 4 allows the remote-controlled start-up of a consumer 2 which is connected to said switching device 4.

A switching device 4 in accordance with the invention comprises an input in form of a current receiving interface 11 in form of terminal screws and an output in form of a current delivery interface 10 in form of a receptacle outlet for example. Furthermore, the switching device 4 comprises a third communication interface 13 which is provided for communication with the control interface 8 of the apparatus 5 and is arranged in a respectively diametrically opposed way.

The switching device comprises switching contacts 12, of which at least one is arranged in a movable way. The switching contacts can be opened and closed, with the switching contacts—in their closed position—closing a current path between the current delivery interface 10 and the current receiving interface 11. It can be provided that the switching device 4 merely comprises switching contacts 12 for interrupting a current path, wherein it is provided in an especially preferred way that a pair of switching contacts 12 is provided for each conductor, i.e. for a neutral conductor and a phase of the energy distribution network 1.

The switching device 4 further comprises an actuator 14 which converts an electric input value into the mechanical motion. It is preferably provided that the actuator 14 is arranged as an electromechanical apparatus such as a lifting magnet or traction electromagnet, wherein actuators can also be provided by utilizing the piezoelectric or magnetostrictive effect.

The actuator 14 comprises a mechanically movable servo component which is connected with the at least one movable switching contact 12.

The switching contacts 12 are mechanically coupled with the actuator 14. The actuator 14 is further connected on its electrical input side by way of circuitry with the third communication interface 13.

It can be provided that further a switching position sensor is provided which can be integrally arranged with the actuator 14 and which is preferably also connected by way of circuitry with the third communication interface 13.

it is further preferably provided that the switching device 4 comprises a voltage or current supply unit, especially a power unit, and that the third communication interface 13 and the actuator 14 are connected with the voltage or current supply unit by way of circuitry.

It is preferably provided that the individual modules of the switching device 4 are arranged in a housing made of insulating material.

FIG. 2 shows a second preferred embodiment of a switching device 4 in accordance with the invention, which has further features in addition to the preferred embodiments as already explained above.

It is preferably provided that the switching device 4 comprises a second control unit 15 which is connected by way of circuitry with the third communication interface 13 and the actuator 14, thus providing the possibility of assuming further tasks in addition to mere switching tasks. The second control unit 15 is preferably arranged as a microcontroller.

It is provided in a further development of the invention and in this context in particular that the switching device 4 comprises a memory for storing an identifier, which memory is connected by way of circuitry with the third communication interface 13 and/or the second control unit 15. This provides the possibility of storing commands, states and measured values and providing them for future evaluation or the further process sequence.

In accordance with the illustrated second preferred embodiment, it is further provided that the second input unit 18 is arranged in the switching device 4. The switching device 4 further preferably comprises at least one first sensor 16 for measuring a current output and/or a power output via the current delivery interface 10, with the first sensor 16 being connected by way of circuitry with the third communication interface 13 and/or the second control unit 15. Such a first sensor 16 is preferably arranged for recording a temporal progression of the current output and/or power output and for the output of a measuring signal. The first sensor 16 is preferably arranged to comprise at least one voltage meter, shunt resistor, measuring transformer and/or Förster probe, with an arrangement of several individual measuring devices and further a second and third sensor being provided especially for power measurement. It can further be provided that the first sensor 16 is provided for measuring the voltage on the current delivery interface 10 and for recording, storing and/or transmitting a voltage signal to the communication interface 13 and/or the second control unit 15. As a result of a subsequent analysis of the signals recorded by the first sensor 16, conclusions can be drawn on the type of the consumer 2. Furthermore, discrepancies between the indicated demand and the actual demand can be recognized and can be taken into account in the repeated operation of said consumer 2.

It can further be provided in a further development that the switching device 4 is arranged for analyzing a temporal progression of the current output and/or power output via the current delivery interface 10 in an image range and/or a frequency range. It can also be provided in this process that the apparatus 5 is arranged in a respective manner as an alternative thereto. The switching device and/or the apparatus therefore preferably comprise a transformation unit, or it is implemented in the first or second control unit 3, 15 in order to enable a transformation of the measuring signal recorded by the first sensor 16 from the time range to a frequency range or an image range, e.g. in applying a wavelet or Gabor transformation. Further possibilities of signal analysis are possible in the image and frequency range.

It is further preferably provided according to the illustrated embodiment in FIG. 2 that the switching device 4 further comprises an indicator or display 19 for the purpose of displaying operating states and inputs.

It can be provided that the apparatus 5 and the switching device 4 are arranged integrally, wherein in this case the first and the second control unit 3, 15 are especially also arranged in an integral manner.

The present invention further relates to a method for controlling energy output to at least one consumer 2 connected to an energy distribution network 1, with the first messages of a utility company being received concerning current and/or future tariffs and/or network capacity utilizations from a first control unit 3, with the consumer 2 being connected to a controllable switching device 4, especially a controllable receptacle outlet, with the energy demand of the consumer 2 and a time frame for covering said energy demand being supplied to the first control unit 3, with the first control unit 3 switching through the switching device 4 within the predetermined time frame during at least one time interval, in which at least one time interval the energy demand of the consumer 2 can be covered at a low expected network capacity utilization and/or a cheapest tariff.

A good and constant capacity utilization of the grid and the energy distribution network 1 can be achieved in this way, wherein there are no objections concerning the protection of the privacy of the subscribers at the same time because no data are transmitted to the utility company. The required energy quantity will be supplied to the consumer 2 in at least one section where the utility company indicated non-critical network capacity utilization. If the utility company merely issues tariff information, the possibility for planning the point in time will be provided at which the respective consumer 2 will be connected with the energy distribution network 1 on the basis of said tariff information, by means of which the same effects will be achieved. Tariffs will usually be arranged by the utility companies with respect to different network capacity utilizations which prevail at different points in time, so that a low-cost tariff at a specific point in time will mean low network capacity utilization and therefore free capacities. Consequently, the “switching control rights” remain with the subscriber and will not be passed on to the utility company.

It is preferably provided that the apparatus 5 merely obtains information from utility companies according to a simple embodiment of the present invention, but usually does not transmit any information to the utility company. It can be provided that data are transmitted nevertheless to the utility company, e.g. data on energy output and the type of the consumer 2 and/or the individual consumer 2. It is preferably provided in this respect however that merely depersonalized or statistically evaluated data over a longer monitoring period for example are transmitted to the utility company. It is therefore preferably provided in a further development of the apparatus 5 that the apparatus 5 comprises a fourth communication interface for transmitting information or data to the first utility company and/or a second utility company.

The method in accordance with the invention provides planning of at least a part of the imminent energy consumption by the apparatus 5 in the respect that specific processes are intentionally performed at times at which the utility company expects low network capacity utilization, e.g. during the night or when additional energy is available in the ambient environment. The method in accordance with the invention is especially provided for operating so-called electricity charging points in which a longer period of time is available for charging the vehicle than is required for the charging process as such. There are currently electric vehicles which can be charged within a period of 1 to 3 hours. If such a vehicle is connected to the grid in the evening for charging, the charging process occurs immediately and therefore usually during periods of the highest network load. The apparatus 5 is informed by the present invention which kind of consumer 2 (e.g. an electric vehicle or washing machine) has been connected to the switching device 4, which energy, power or work demand is provided by this apparatus, and within which period of time this demand will occur; therefore the point in time up to which the electric vehicle shall be fully charged or the washing machine shall have completed the washing. It can additionally be provided (e.g. when connecting the electric vehicle during the peak hours in the evening) to supply the remaining current stored in the batteries of the electric vehicle to the in-house supply network. This reduces the total load on the network and leads to the economic advantage that current can be saved during the peak tariff in the evening and charging is performed at a later point in time of lower network load and cheaper tariffs. The electric vehicle will be used in this case merely as an energy storage unit.

The apparatus 5 determines from the available data the points in time at which the connected consumers 2 are put into operation or the points in time at which the energy demand is to be covered, and makes the switching device or devices 4 close switching contacts 12 at the determined points in time.

It is preferably provided that the apparatus 5 determines the points in time for providing the energy in an iterative process, with no linear optimization algorithm preferably being provided because such an algorithm would require a very high computing effort. Instead, a respectively optimized algorithm will be used.

It is further provided to use so-called soft decisions or fuzzy logic. The apparatus makes its decisions on the basis of the available information, which in addition to the information is also provided with a probability value. Considerably better results can be achieved in this way than before.

It can be provided that the subscriber or user of the apparatus 5 announces whether low network capacity utilization or low costs are prioritized, or the point in time at which the energy demand needs to be covered. As a result, the apparatus can strive to achieve a compromise in the event that no satisfactory solution that meets all input parameters can be found, which compromise meets the user's requirements.

After termination of the energy consumption by the consumer 2 or after the expiration of the time frame, the switching device 4 will be switched off by the first control unit 3. If the energy consumption concerns a charging process or a program-controlled process such as a washing program, the consumer 2 will terminate the energy consumption by itself.

If the switching device 4 comprises a first sensor 16, this can be determined and consequently the switching device 4 can be switched off after allowing a predetermined time interval to pass for example.

It can further be provided that the utility company transmits an emergency code to the apparatus 5, which thereupon opens the switching contacts 12 of all connected switching devices 4 and consequently deactivates all connected consumers 2. This is advantageous in the case of a network failure for example, because the lowest possible network load is important for starting up the network again and the connected power plants.

In addition to manual input, it is especially provided for transmitting the [symbol] ergy demand of the consumer 2 to the first control unit 3 that the energy demand [symbol] the consumer 2 is transmitted electronically to the first control unit 3 and is stored [symbol] ere. This allows especially taking into account the possibility of a demand curve [symbol] er time of the consumer.

Such a temporal progression, which is especially advantageous for [symbol] timizing the network capacity utilization since load peaks can be compensated very [symbol] all in this way, can also be determined, especially when the same device or the [symbol] me consumer 2 is operated repeatedly in the apparatus 5 or a switching device 4 [symbol] sociated with said apparatus. It is preferably provided in this respect that a [symbol] mporal progression of the energy output is measured substantially during the entire [symbol] ergy output up to covering the energy demand of the consumer 2 and is [symbol] ansmitted in form of energy output data to the first control unit 3. As a result, the [symbol] orementioned possibilities of especially good network capacity utilization will also [symbol] e available in consumers 2 for which the respective information is not available.

It is further provided in this connection that from a plurality of stored energy [symbol] uput data concerning a specific consumer 2 the stored energy demand of said) [symbol] pecific consumer 2 is adjusted in predeterminable time intervals by the first control [symbol] it 3 to the actual energy output that has occurred up until such a point in time. [symbol] urther optimization can occur by such an adjustment.

In the method in accordance with the invention it is necessary to inform the [symbol] paratus 5 about the consumer 2 or device which is connected to the current [symbol] elivery interface of the switching device 4. It can be provided for this purpose to [symbol] erform a respective input in the first and first or second input device for example. It [symbol] an further be provided for the automatic recognition of the consumer that after the [symbol] onnection of the consumer 2 to the switching device 4 the switching device 4 is [symbol] witched through for a predeterminable period of time, that subsequently a time progression of the energy output is determined and therefrom at least one type of the connected consumer 2 is determined. If the energy demand and a time frame for covering said energy demand is already stored in connection with the connected consumer 2 and they are not to be changed, all required parameters are consequently available to the apparatus 5. This leads to an especially user-friendly implementation of the method in accordance with the invention.

Concerning an analysis of the recorded measuring signals which are representative of a time progression of the energy output, a transformation in the frequency range or an image range is advantageously provided, with especially the application of an FFT, DFFT, DCT, wavelet or Gabor transformation being provided. The processing of at least one measuring signal as a digital signal is especially advantageous in this connection.

The present invention further relates to a method for controlling the energy supply of at least one consumer 2 connected to an energy distribution network 1, which method shall subsequently be related to as the second method, with energy purchase guidelines being transmitted by a user to a first control unit 3, with at least one first message of a first utility company being received by the first control unit 3, with at least one second message of a second utility company being received by the first control unit 3, with the first control unit 3 respectively checking the first and the second utility company for fulfillment of the energy purchase guidelines on the basis of at least first and second message, with the utility company being chosen from the first and the second utility company for the supply of energy of the at least one consumer 2 which fulfills the energy purchase guidelines better than the respective other utility company.

It can be ensured in this way that a subscriber of an energy distribution network 1 (if available and offered) will be supplied with such energy which meets the demands of the subscriber concerning costs or environmental compatibility for example. This allows the subscriber and consumer to have an effect on the utility company by intentional predetermination of the energy purchase guidelines because subscribers may be willing to pay higher prices for electricity and/or heat produced in an especially ecologically sustainable manner than for electricity from an atomic power plant.

In addition to a first and a second utility company, any further number of utility companies can be provided and can be evaluated by means of the method in accordance with the invention.

The first and the second message are preferably arranged according to the first message as already explained above.

The first and the second utility company preferably concern a utility company for the supply with electrical and/or thermal energy (long-distance heat).

Energy purchase guidelines preferably designate target values of the subscriber or user concerning specific priorities which need to be taken into account in the delivery of energy, i.e. whether the energy shall be purchased at the lowest possible cost, with the lowest possible network load, with the lowest possible pollution to the environment, with the lowest possible CO₂ load and/or with the highest possible share in renewable energy.

After the receipt of the first and second messages, they are subsequently evaluated as to which of the utility companies meets the predetermined parameters in the best possible way, which is selected thereupon. It can be provided in this respect in a further development of the invention that during the check of the first and second utility company at least one first value is determined for the fulfillment of the energy purchase guidelines by the first utility company and at least one second value is determined for the fulfillment of the energy purchase guidelines by the second utility company. It is subsequently provided that the at least one first value is compared with the at least one second value.

It can be provided alternatively and in a further development that an evaluation matrix is prepared, wherein different weightings of different parameters can also be provided and said evaluation matrix is evaluated.

It can be provided depending on the type of the utility company that after the selection of the respective utility company the energy is purchased at least for a specific period from said utility company without any further communication with said company, e.g. when the respective utility company concerns such a utility company with which the subscriber has a delivery agreement anyway and said delivery agreement comprises the chosen tariff.

It can also be provided (e.g. when there is no special agreement with the chosen utility company) that the chosen utility company is informed about the selection for energy supply of the at least one consumer 2. Consequently, the subscriber purchases energy or the right to receive energy within a specific period of time under specific conditions. After the delivery of the energy via the energy distribution network 1, to which the subscriber or consumer is connected, the utility company which is in possession of the respective energy distribution network 1 will settle the costs with the chosen utility company.

It is preferably provided that the respective second method is carried out by means of an apparatus 5 or an arrangement described especially in the drawings. It is especially further provided that an apparatus 5 in accordance with the invention is arranged on a mobile consumer 2 such as an electric vehicle. As a result, electricity can also be purchased outside the home country similar to roaming as in the case of mobile phones and can be purchased from utility companies which fulfill specific criteria.

It is provided according to the present invention that for planning and/or controlling energy output to a consumer and/or energy supply to an energy distribution network 1, the probabilities of the occurrence of the respective tariffs and/or network capacity utilizations will be generated and transmitted. It is preferably provided that the respective first messages are received by a first control unit 3.

This provides the possibility of more flexible planning of the tariffs and the network capacity utilization. In this process, not only one tariff will be offered or a network capacity utilization will be forecast, but the respective information which can be supplemented by additional information are provided with an additional probability value, which probability value indicates the probability with which the information will occur. The probability value can also be adjusted continuously by repeated updates of the first messages. This provides the consumers for example with the possibility of planning energy purchases over a longer period of time because it can be estimated whether the respective tariff will actually occur depending on the weather conditions for example. This further offers the possibility to offer more frequent and different tariffs for energy suppliers, because they can be adjusted over time until they actually occur. On the consumer side, this leads to the special advantage that the purchase of energy can be planned over a longer period of time and more flexibly. Especially by comparing the so-called tariff and network load forecasts of different suppliers and energy suppliers, which may also comprise an in-house photovoltaic system, one's own energy consumption, the time frame of such consumption and optionally separate energy production can be planned in a better way. As a result, the load on the electricity distribution networks can be reduced and the energy costs for the consumers can be decreased. As a result, better capacity utilization of the electricity distribution networks can be enabled and an expansion of the electricity distribution networks can be avoided.

Several energy suppliers will be available in numerous applications for covering the occurring energy demand. It can typically be provided that the first energy supplier and the consumer are arranged within a local first energy distribution network, especially within a household. A second energy supplier can be a conventional utility company or a small-size power plant of a neighbor. The energy suppliers prepare and transmit second messages concerning expected current and/or planned tariffs and/or network capacity utilizations, and concerning a value for a probability of the occurrence of the respective tariffs and/or network capacity utilizations. It is understood that further energy suppliers can be provided which also transmit respective messages.

As has already been explained above, it is provided that the energy demand of a consumer 2 which is connected to a controllable switching device and a time frame for covering said energy demand is sent to the first control unit 3. The first control unit 3 now determines a schedule for the energy output to the consumer on the basis of information which is contained in the first and/or second messages. It is provided that the first control unit applies the means of fuzzy logic. It is further provided after determining a schedule that the switching device 4 is switched through within the predetermined time frame according to the determined schedule.

Planning can now take into account changing weather conditions for example on the basis of the data that is now available. In this process, the type of the different consumers can further be taken into account, e.g. a larger supply risk can be accepted in non-critical consumers in order to achieve a better price in this way. It can be agreed for example that there is a low value for the probability that an offered energy delivery quantity or power entails an especially low price, especially when the probability value is so low that total failure can be expected. As a result, a useful and demand-oriented network planning can also occur in the case of especially unstable weather conditions and continually changing probability values for example.

As a result of the probability values, the messages allow a more frequent issuing of different tariffs and better planning of energy management, especially in the area of the end consumer. Especially energy consumers which additionally operate own energy suppliers are granted considerably better possibilities for planning and control, thus especially exerting an effect on the energy distribution network in addition to economic improvement.

It is provided in a further development of the present method that when a planned energy delivery quantity according to the first messages is larger than the demand of the consumer a third message is generated concerning the energy quantity available in a planned time frame, the planned tariff and the probability for maintaining the energy quantity and the tariff, and that the third message is transmitted within a regional second energy distribution network. Efforts can be made in the case of energy production which exceeds the allocated or required delivery quantity by a consumer to sell the excess energy quantity in a locally adjacent area. As a result of the third message which also contains a probability value, a potential purchaser can already include the respective energy quantity in his or her planning at an early point in time. The trans-regional network load can be reduced by offering or selling the energy in the area of production.

It can be provided for example that the third message is distributed to consumers in the area of the next higher energy distributor. If no purchaser is found within a predeterminable period of time, the respective message can be dispatched to a higher level, etc.

For example, the forecasts of a household with a photovoltaic system can lead to the result that more energy is generated as a result of high solar radiation than is consumed at this point by said household. Instead of storing this energy, a third message is dispatched within a specific area around the household (e.g. within a street or a community). In this respect, it is managed to use the generated current within an adjacent area and long-distance capacity can be saved as a result.

Any type of energy storage unit can further also be regarded as an energy supplier. It can be provided for example to load electrical energy which is stored in an electric vehicle into the network under high tariffs or under strong network capacity utilization and that the electric vehicle is fully charged at a later point in time at cheaper tariffs.

As a result of the probability values, this can be planned in a better way than in the past.

It can be provided that partial steps of the proposed methods are respectively performed on different or by different apparatuses.

1-15. (canceled)

16. A method for planning or controlling an energy supply to a consumer or to an energy distribution network, comprising the steps of:
generating at and transmitting from a first energy supplier first messages selected from current tariffs or planned tariffs to be expected, an expected network capacity utilization, a probability that the expected current or planned tariffs will actually occur, and a probability that the expected network capacity utilization will actually occur,
generating at and transmitting from a second energy supplier second messages selected from current or planned tariffs to be expected, an expected network capacity utilization, a probability that the expected current or planned tariffs will actually occur, and a probability that the expected network capacity utilization will actually occur,
receiving at least one of the first and second messages with a first control unit,
informing the first control unit about an energy demand of a consumer connected to a controllable switching device and a time frame for covering the energy demand,
determining with the first control unit a time schedule for supplying energy to the consumer based on at least one of the first messages and the second messages, and
connecting the switching device through within the time frame according to the determined schedule.

17. The method of claim 16, wherein the first energy supplier and the consumer are arranged within a local first energy distribution network.

18. The method of claim 17, wherein the first energy supplier and the consumer are arranged within a household.

19. The method of claim 16, further comprising the steps of:
analyzing meteorological forecast data and statistical network loading data,
planning at least one of tariffs and network loads based on the analyzed data, and
determining a value representative of a probability for maintaining the planned tariffs or network loads.

20. The method of claim 16, further comprising the steps of:
when a planned energy supply quantity according to the first messages is greater than a demand from the consumer, generating a third message concerning an available energy quantity within a planned time frame, the planned tariff and a probability for maintaining the energy quantity and the planned tariff, and
transmitting the third message within a regional second energy distribution network.

21. The method of claim 20, wherein at least one of the first, second and third messages comprises information selected from the group consisting of planned deliverable energy quantity, planned deliverable electrical power, maximum available power and planned deliverable electrical current.

22. The method of claim 16, further comprising the steps of:
after the consumer is connected to the switching device, connecting the switching device through for a predetermined time,
subsequently determining a temporal profile of the energy output, and
determining therefrom at least one type of the connected consumer.

23. The method of claim 22, further comprising the steps of:
measuring the temporal profile of the energy output substantially until the energy demand of the consumer is met, and
transmitting the temporal profile in form of energy output data to the first control unit.

24. The method of claim 23, further comprising the step of:
based on a plurality of stored energy output data for a specific consumer, adjusting with the first control unit a stored energy demand of the specific consumer at predetermined time intervals to an actual prior energy output that has occurred up to the predetermined time intervals.
